(19) United States
(12) Patent Application Publication
(10) Pub. No.: US 2025/0314781 A1
(43) Pub. Date: Oct. 9, 2025

(54) MULTI-PROTOCOL FIREFIGHTER LOCATING

(71) Applicant: 3M INNOVATIVE PROPERTIES COMPANY, St. Paul, MN (US)

(72) Inventors: Darin K. Thompson, Huntersville, NC (US); William B. Howell, Pineville, NC (US); Richard J. Sabacinski, Charlotte, NC (US); Longin J. Kloc, Charlotte, NC (US); Jeremy V. Barbee, Oakboro, NC (US); Eric J. Bassani, Denver, NC (US); David A. Amero, Calgary (CA); Ivan M. Delamer, Calgary (CA); Zachary R. Rivard, Calgary (CA); Michael J.Z. Norton, Calgary (CA); Daniel W. Soppit, Rocky Mountain House (CA)

(21) Appl. No.: 19/172,576

(22) Filed: Apr. 7, 2025

Related U.S. Application Data
(60) Provisional application No. 63/631,217, filed on Apr. 8, 2024.
(60) Provisional application No. 63/631,210, filed on Apr. 8, 2024.

(51) Int. Cl. G01S 19/17

(52) U.S. Cl. CPC G01S 19/17

(57) ABSTRACT

A locating device includes a first locating interface, a second locating interface, and a third locating interface each configured to transmit a different packet size over a different protocol. The locating device is configured to communicate with a beacon. Depending on the capability of the beacon, the locating device may selectively initiate a tracking routine.

### CROSS REFERENCE TO RELATED APPLICATIONS

This application claims priority from U.S. Provisional Application Ser. No. 63/631,210, filed 8 Apr. 2024, and U.S. Provisional Application Ser. No. 63/631,217, filed 8 Apr. 2024, the disclosure of which is incorporated by reference in its/their entirety herein.

### TECHNICAL FIELD

The present technology is generally related to multi-protocol locating techniques and, in particular, to multi-protocol locating devices, systems, and methods for locating firefighters with wearable beacons.

### SUMMARY

In one aspect, the present disclosure relates to a locating device including a first locating interface configured to receive a first locating signal over a first communication protocol and provide first locating data; a second locating interface configured to receive a second locating signal over a second communication protocol different than the first communication protocol and provide second locating data; a third locating interface configured to receive a third locating signal over a third communication protocol different than the first and second communication protocols and provide third locating data; and a controller operably coupled to the first locating interface, the second locating interface, and the third locating interface, the controller having processing circuitry and memory. The controller is configured to: monitor the first locating interface for the first locating data; in response to receiving the first locating data having a first unique identifier of a wearable beacon, determine whether the wearable beacon is capable of transmitting at least three different locating signals based on at least the first locating data; in response to determining that the wearable beacon is capable of transmitting at least three different locating signals, initiate a range tracking routine, a direction tracking routine, or both; in response to initiating the range tracking routine, determine a range tracking parameter in response to the second locating data; and in response to initiating the direction tracking routine, determine a direction tracking parameter based on at least the first locating data and the third locating data.

In another aspect, the present disclosure relates to a method for using a locating device. The method includes: monitoring a first locating interface of the locating device for first locating data; in response to receiving the first locating data having a first unique identifier of a wearable beacon, determining whether the wearable beacon is capable of transmitting at least three different locating signals based on at least the first locating data; in response to determining that the wearable beacon is capable of transmitting at least three different locating signals, initiating a range tracking routine, a direction tracking routine, or both; in response to initiating the range tracking routine, determining a range tracking parameter in response to second locating data from the wearable beacon; and in response to initiating the direction tracking routine, determining a direction tracking parameter based on at least the first locating data and third locating data from the wearable beacon.

In one aspect, the present disclosure relates to a locating device including a first locating interface configured to receive a first locating signal over a first communication protocol and provide first locating data having a first packet size; a second locating interface configured to receive a second locating signal over a second communication protocol different than the first communication protocol and provide second locating data having a second packet size greater than the first packet size; a third locating interface configured to receive a third locating signal over a third communication protocol different than the first and second communication protocols and provide third locating data having a third packet size greater than the first packet size; and a controller operably coupled to the first locating interface, the second locating interface, and the third locating interface, the controller having processing circuitry and memory. The controller is configured to monitor the first locating interface for the first locating data; in response to receiving the first locating data having a first unique identifier of a wearable beacon, determine whether the wearable beacon has bidirectional communication capability based on at least the first locating data; in response to determining that the wearable beacon has bidirectional communication capability, initiate a range tracking routine, a direction tracking routine, or both; in response to initiating the range tracking routine, establish bidirectional communication with the wearable beacon to receive the second locating data and determine a range tracking parameter in response to the second locating data: and in response to initiating the direction tracking routine, determine a direction tracking parameter based on at least the first locating data and the third locating data.

In another aspect, the present disclosure relates to a method of using a locating device. The method includes: monitoring a first locating interface of the locating device for first locating data from a wearable beacon: in response to receiving the first locating data having a first unique identifier of the wearable beacon, determining whether the wearable beacon has bidirectional communication capability based on at least the first locating data; in response to determining that the wearable beacon has bidirectional communication capability, initiating a range tracking routine, a direction tracking routine, or both; in response to initiating the range tracking routine, establishing bidirectional communication with the wearable beacon to receive the second locating data and determining a range tracking parameter in response to second locating data from the wearable beacon; and in response to initiating the direction tracking routine, determining a direction tracking parameter based on at least the first locating data and third locating data from the wearable beacon.

In another aspect, the present disclosure relates to a system including a wearable beacon configured to transmit at least three different locating signals each over a different communication protocol and the locating device.

Aspects of the present disclosure provide techniques for using multiple locating interfaces in a single locating device to determine both directional and range-based information of a wearable beacon in an environment. A first locating interface, configured with an extended coverage communication protocol, acquires preliminary directional information. A second locating interface, configured for short-range distance measurement, generates a range tracking parameter. A third locating interface, which employs a wideband communication protocol, refines directional information. By integrating these parameters, the system or method produces a comprehensive location result that may be displayed to a user for improved beacon tracking.

Aspects of the present disclosure further provide that the first locating interface can implement a Zigbee-based protocol or other high-level standard, facilitating longer-range communication. Meanwhile, the second locating interface may employ multi-carrier phase difference, round-trip timing, or time-of-flight measurements for highly accurate short-range distance calculation. The third locating interface, utilizing a wideband approach, can resolve phase or angle-of-arrival data to achieve additional directional precision.

Aspects of the present disclosure also contemplate the integration and filtering of data from multiple locating interfaces to mitigate inaccuracies. For example, outlier filtering routines can be applied to compare multiple measurement outputs, discarding readings outside a predefined accuracy threshold. This approach preserves robust performance under varying environmental conditions and enhances reliability of the computed location.

Aspects of the present disclosure describe enhancements to user interaction, including providing a combined visualization of both the refined directional parameter and the range tracking parameter on a user interface. This graphical representation can guide a user quickly and intuitively toward a beacon's position within a structure or an emergency environment.

Aspects of the present disclosure include adaptive power controls and frequency parameter tuning, whereby the locating device monitors real-time signal metrics from the beacon and adjusts its transmission or reception characteristics for optimized performance. The location result and optional sensor readings, such as air level or battery levels from the beacon, may be stored in a data log for subsequent retrieval or post-incident review by authorized personnel.

Aspects of the present disclosure further describe a system embodiment, where a controller manages first, second, and third locating interfaces. The controller acquires preliminary direction via the extended-coverage interface, refines that direction via the wideband interface, and uses short-range distance measurement for establishing a range tracking parameter. The controller then merges directional and range data to yield a location result, which is displayed to a user. Certain implementations employ instructions that execute outlier filtering or secure communications, thus enabling consistent and protected operation across diverse environments.

### BRIEF DESCRIPTION OF DRAWINGS

FIG. 1 is a diagram of an environment for using a locating device with a wearable beacon according to the present disclosure.

FIG. 2A and FIG. 2B are an overhead view and a side elevation view of a locating device usable as the locating device of FIG. 1.

FIG. 3 is a schematic diagram of a locating device usable as the locating device of FIG. 1.

FIG. 4 is a flow diagram of a locating method usable with the locating device of FIG. 1.

FIG. 5 is a flow diagram of a range tracking method usable with the locating method of FIG. 4.

FIG. 6 is a flow diagram of a direction tracking method usable with the locating method of FIG. 4.

FIG. 7 is a view of a one example of a user interface for indicating range, direction, or both of a wearable beacon usable with the locating device of FIG. 1.

FIG. 8 is a view of one example of a user interface for prioritizing wearable beacons usable with the locating device of FIG. 1.

The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### DETAILED DESCRIPTION

In general, the present disclosure relates to a locating device including a first locating interface, a second locating interface, and a third locating interface each configured to transmit a different packet size over a different protocol. The locating device is configured to communicate with a beacon. Depending on the capability of the beacon, the locating device may selectively initiate a tracking routine.

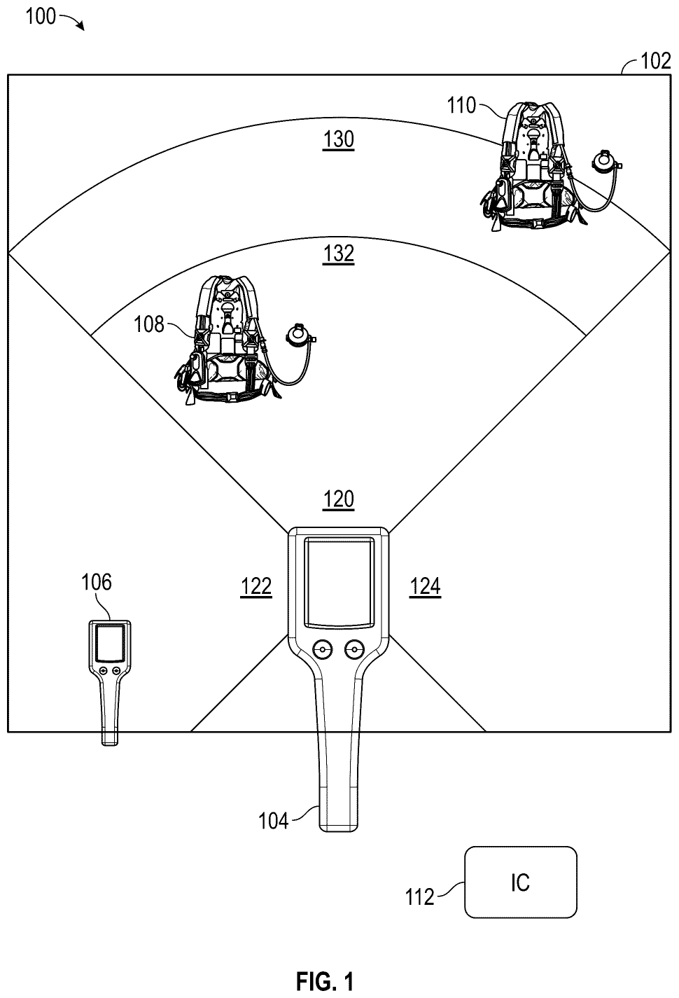

FIG. 1 is a diagram of an environment 100 for using a locating device 104 with a wearable beacon, or simply a beacon, such as wearable beacon 108 or wearable beacon 110, according to the present disclosure. The environment 100 may be any environment in which a beacon is worn by an individual who may need to be located, for example, when the environment is an immediately dangerous to life or health (IDLH) environment. In some embodiments, the environment 100 is a firefighting scene and one or more beacons may be worn by a firefighter. The beacons may activate an alarm state, such as a Personal Alert Safety System (PASS) alarm, when a firefighter is in distress in the environment. The locating device 104 may be used to facilitate finding the beacons in the environment 100 and may provide audio, visual, or both types of feedback to a user of the locating device 104 related to the location of the beacon.

The wearable beacons may be attached, or otherwise coupled to, a wearable support device. One example of a wearable support device is a Self-Contained Breathing Apparatus (SCBA). Although reference is made herein to environments involving use of the locating device with a wearable beacon integrated into, or attached to, an SCBA, the locating advice may be used with a wearable beacon integrated into, or attached to, any wearable article or support device usable in environments where a user with the wearable beacon may need to be found or otherwise tracked. Various other applications will become apparent to one of skill in the art having the benefit of the present disclosure. In general, an SCBA may include a backframe configured to support a high-pressure air tank, a harness including a shoulder strap connected to a backframe, a sensor module mounted to the backframe, and at least one or more beacon interfaces each configured at least to transmit or receive signals over a communication protocol and provide at least one beacon signal.

In some embodiments, the environment 100 includes a structure 102, such as a building, which may include one or more obstacles, such as walls or floors, between the user of locating devices, who may be part of a Rapid Intervention Team (RIT), and the individuals wearing the wearable beacons, who may be firefighters in PASS alarm. Within a structure 102 of an environment 100, there may be multiple individuals with beacons 108, 110 and multiple users each with a locating device 104, 106 searching for the individuals.

Various existing locating devices utilize Received Signal Strength Indicator (RSSI) of a one-way beacon signal from a beacon to provide a proxy for a distance from the locating device to the beacon. However, such a system utilizing RSSI provides only an approximate distance that is affected by environmental factors, such as humidity, electromagnetic interference, multipath propagation, signal attenuation through different objects, and does not innately provide directional information that can be used to guide the user of the locating device toward the beacon. Some existing locating devices utilize multiple fixed antennas to provide directional information. However, utilizing a fixed antenna with RSSI may require movement of the locating device in a sweeping motion in order for the user to determine the direction of the beacon relative to the orientation of the locating device. Such a movement may take seconds and steady movement, which can be challenging for users in emergency situations. In addition, the information relayed to locating devices directly in various existing systems is limited and lacks sufficient information to facilitate efficient searching for multiple individuals having beacons in the alarm state.

The present disclosure provides a locating device capable of communicating over a plurality of communications protocols. In some embodiments, data from multiple communications protocols are used to provide tracking information of at least one beacon to the user of the locating device. In some embodiments, at least one of the communications protocols is a bidirectional communication protocol. Establishing bidirectional communication may be used to transfer locating data between the locating device and the at least one beacon. The bidirectional locating data may be used to improve tracking accuracy and may provide an indication of search status or progress to the individual wearing the beacon (e.g., the firefighter may be informed of being searched for). In some embodiments, at least one communication protocols may be used to establish communication with one or more other devices in the environment to transfer search data between the locating devices and/or Incident Command (IC), which may facilitate improved communications efficiency between individuals on the scene, as well as IC. The search data may be used, for example, to facilitate assigning the locating device to search for one of the beacons, or to otherwise prioritize the beacons, when multiple beacons are in alarm in an environment. In some embodiments, the search data may include one or more parameters of the locating data.

Although reference herein is made to the configuration of the locating device 104, the locating device 106 may be configured in the same or similar manner. In general, the locating interface 104 uses multiple locating interfaces to provide an indication or range, direction, or both of at least one beacon to a user of the locating device. The locating device 104 includes a plurality of locating interfaces each configured to receive a locating signal over a different communication protocol. The various locating interfaces are generally configured to operate over various effective ranges in a nominal environment. As used herein, the term “nominal environment” refers to a freespace environment where the locating device and the corresponding beacon have a clear line of sight to one another. For example, in some embodiments, a first communications protocol may have a largest effective range up to and including first range area 130, a second communications protocol may have an intermediate effective range up to and including second range area 132. However, the second communications protocol may have better accuracy than the first communications protocol. The effective range may be determined by the particular protocol and may refer to the range at which the protocol is able to reliably transmit certain parameters, for example, from the beacon to the locating device.

The communication protocols may also be defined by other parameters, such as center frequency, packet size, bandwidth, communications standard, and directional capability (e.g., one-directional or bidirectional communication). Although various types of communications protocols are contemplated, in some embodiments, at least some or all of the communications protocols are Wireless Personal Area Networks (WPANs). In some embodiments, a first communications protocol may have a first packet size and other communications protocols may have packet sizes each larger than the first packet size. For example, a second, third, and fourth communications protocol may each have a packet size larger than the first packet size. In some embodiments, the communication protocols of the locating interfaces may conform to one or more of the IEEE 802.15.4 standard, the IEEE 802.15.4z standard having an ultrawide bandwidth (UWB), the BLUETOOTH AoA protocol, a Multi-Carrier Phase Difference (MCPD) protocol, among others. Utilizing the multiple protocols, the locating device 104 may provide a greater tracking range and more accurate tracking information than using only one or two protocols (e.g., 75 meter effective range and 0.3 to 1 meter range accuracy versus 10 meter range accuracy).

Each locating interface may be associated with a set of one or more antenna. Each set may be oriented to receive a signal more strongly from a certain direction than other directions. In some embodiments, the locating device 104 may define various direction areas, which may correspond to an angle range. For example, the locating device 104 may define a first direction area 120, a second direction area 122, and a third direction area 124. Each direction area may be associated with an antenna set configured to receive signals strongly in a range of 90 degrees and each direction area may be offset from one another to collectively cover 270 degrees. Such a configuration of antenna may allow one or more locating interfaces to provide directional information, without sweeping the locating device, and by monitoring the differences in signals between the antenna. In some embodiments, one locating interface may be associated with three sets of antenna with each antenna set corresponding to one of the direction areas 120, 122, 124. As described herein in further detail, not all locating interfaces of the locating device 104 utilize a sweeping motion to provide directional information to the user.

In some embodiments, the locating device 104 is configured to receive beacon signals from multiple wearable beacons. For example, the locating device 104 may receive a beacon signal from the wearable beacon 108 and the wearable beacon 110. Locating data may be determined, or interpreted, based on the beacon signal. Such locating data may be used to determine a priority level for each beacon. In some embodiments, locating data may be used, for example, in a user-configurable manner to determine the beacon with the highest priority. For example, the locating data may include a device air level (e.g., SCBA air level), and the locating device 104 may prioritize the beacon associated with the lowest device air level. In another example, the locating data may indicate a distance (e.g., a range parameter) to each beacon, and the locating device 104 may prioritize the beacon with the lowest distance from the locating device first and, in general, may order the beacons in priority by lowest distance.

In some embodiments, the locating device 104 is configured to communicate with devices other than the beacons. Other devices may include another locating device 106 or the IC device 112. The IC device 112 may be used by an Incident Commander overseeing the search in the environment. The locating device 104 may include a wireless communications interface configured to communicate with the other devices. Various data related to the on-site search may be transmitted among these devices, which may be described as search data.

Search data from other locating devices, such as the locating device 106, may be received the locating device 104 and be used to determine which beacon should be prioritized by the locating device 104. For example, the locating devices 104 may share their respective distances to each of the beacons in the search data, and each locating device 104 may uniquely prioritize the beacons by distance and optionally other parameters to more efficiently deploy the locating device users, such as only assigning one locating device to one beacon so that as many individuals in alarm states are searched for in parallel as possible. Other techniques for utilizing the search data may be utilized by those having ordinary skill in the art and the benefit of this disclosure.

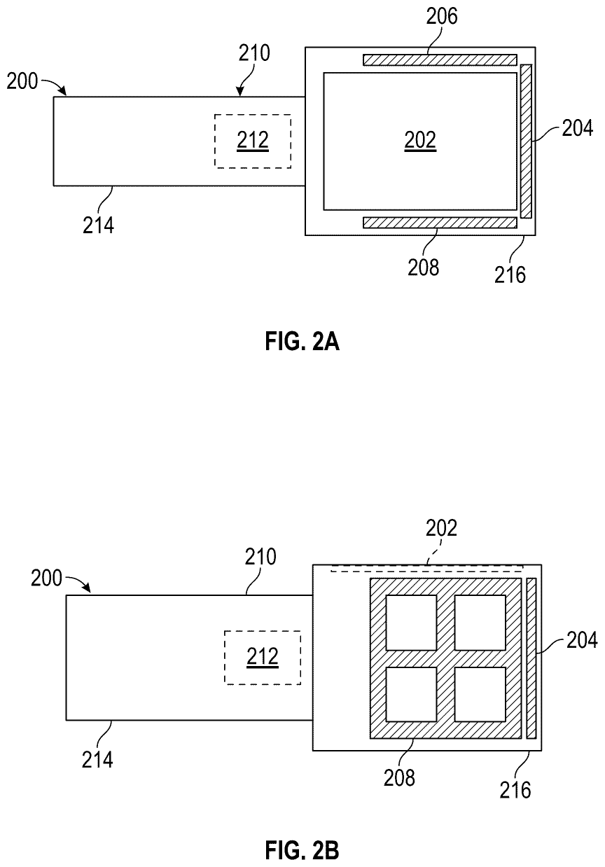

FIG. 2A and 2B are an overhead view and a side elevation view of a locating device 200 usable as the locating device 104 of FIG. 1. In some embodiments, the locating device 200 is a handheld device. The locating device 200 includes a housing 210 having at least a handle portion 214 and a body portion 216, a user interface 202 coupled to the body portion of the housing, and one or more sets of antenna coupled to and at least partially contained within the housing. As illustrated, the locating device 200 includes four sets of antenna 204, 206, 208, and 212.

One, two, or three of the sets of antenna 204, 206, 208 may be part of a same set of locating interfaces. For example, the antenna sets 204, 206, 208 may be part of one or two locating interfaces, such as those utilizing a protocol conforming to the IEEE 802.15.4 standard or the BLUETOOTH AoA protocol.

Each antenna set 204, 206, 208 may include patch antenna (see FIG. 2B). In the illustrated embodiment, each antenna set 204, 206, 208 includes four patch antenna. In other embodiments, each antenna set 204, 206, 208 may include only two patch antenna, particularly antenna sets 206, 208, which may save space while still providing sufficient fidelity. Each antenna set may correspond to receiving signals strongly on a focused angle range indicated by the different direction areas of FIG. 1. For example, antenna set 204 may correspond with direction area 120, antenna set 206 may correspond with direction area 122, and antenna set 208 may correspond with direction area 124. The BLUETOOTH AoA protocol may not require sweeping the locating device 104 in order to provide tracking data, such as direction tracking data.

In some embodiments, one or two additional antenna sets (not shown) may be provided, each associated an upward or downward orientation. Each of the antenna sets oriented in the upward direction area (not shown) or downward direction area (not shown) may include one, two, or four patch antenna. In this configuration, the locating device 200 may be configured to provide directional information to the user in three dimensions (e.g., forward, left, right, up, and down).

The antenna set 212 may be used for other communication protocols, such as protocols conforming to the IEEE 802.15.4z standard having UWB and an MCPD protocol. These protocols may not require sweeping of the locating device 104 in order to provide tracking data, such as range tracking data. The antenna set 212 may include one, two, or more antenna in the set. In some embodiments, each protocol in utilizes its own antenna in antenna set 212.

The antenna sets 204, 206, 208 are shown in the body portion 216 and the antenna sets 212 are shown in the handle portion for illustrative purposes only. In general, the antenna sets 204, 206, 208, 212 may be disposed anywhere in, or on, the housing of the locating device 104. A person of ordinary skill in the art having the benefit of the present disclosure would be able to position the antenna sets in a suitable location.

The user interface 202 may be any suitable user interface. In some embodiments, the user interface 202 is a graphical user interface capable of displaying visual indicators to the user. A non-limiting example of a suitable user interface may include one or more of a graphical display, a light-emitting diode (LED), or combinations of these.

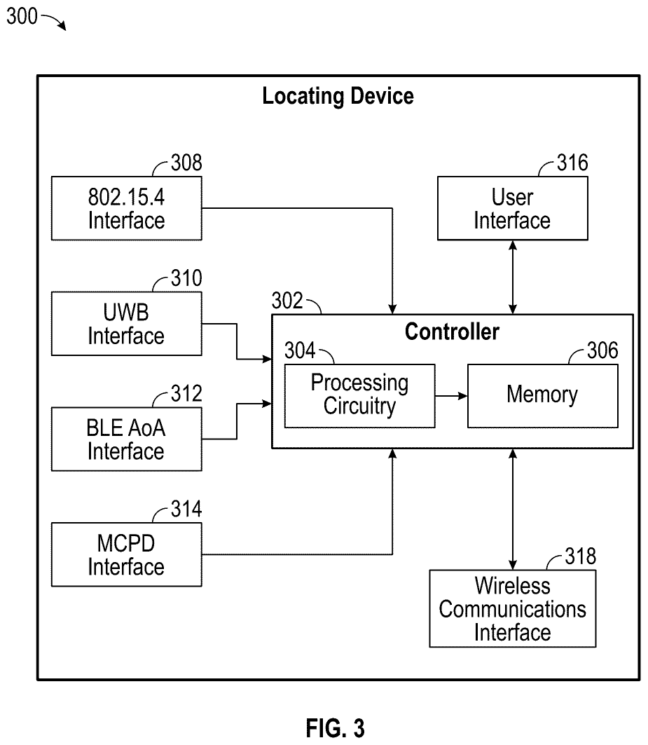

FIG. 3 is a schematic diagram of a locating device 300, which is usable as the locating device 104 of FIG. 1 or the locating device 200 of FIG. 2. The locating device 300 includes at least one controller 302 operably coupled to at least one locating interface and including processing circuitry 304 and at least one memory 306.

One or more of the components of the locating device 200, such as controllers or interfaces, described herein may include processing circuitry, such as a processor, central processing unit (CPU), computer, logic array, or other device capable of directing data coming into or out of the locating device. The controller may include one or more computing devices having memory, processing, and communication hardware. The controller may include circuitry used to couple various components of the controller together or with other components operably coupled to the controller. The functions of the controller may be performed by hardware and/or as computer instructions on a non-transient computer readable storage medium.

The processor of the controller may include any one or more of a microprocessor, a microcontroller, a digital signal processor (DSP), an application specific integrated circuit (ASIC), a field-programmable gate array (FPGA), and/or equivalent discrete or integrated logic circuitry. In some examples, the processor may include multiple components, such as any combination of one or more microprocessors, one or more controllers, one or more DSPs, one or more ASICs, and/or one or more FPGAs, as well as other discrete or integrated logic circuitry. The functions attributed to the controller or processor herein may be embodied as software, firmware, hardware, or any combination thereof. While described herein as a processor-based system, an alternative controller could utilize other components such as relays and timers to achieve the desired results, either alone or in combination with a microprocessor-based system.

In one or more embodiments, the exemplary systems, methods, interfaces, and other functionality may be implemented using one or more computer programs using a computing apparatus, which may include one or more processors and/or memory. Program code and/or logic described herein may be applied to input data/information to perform functionality described herein and generate desired output data/information. The output data/information may be applied as an input to one or more other devices and/or methods as described herein or as would be applied in a known fashion. In view of the above, it will be readily apparent that the controller functionality as described herein may be implemented in any manner known to one skilled in the art.

In some embodiments, the controller 302 is operably coupled to at least one or more of a first locating interface 308, a second locating interface 310, a third locating interface 312, and a fourth locating interface 314. In some embodiments, the controller 302 is operably coupled to only three of the locating interfaces. In other embodiments, the controller 302 is operably coupled to more than four locating interfaces.

The first locating interface 308 may be configured with a communications protocol that conforms to the IEEE 802.15.4 standard. The signals received by the first locating interface 308 may have a center frequency of 2.4 GHz. The signals received by the first locating interface 308 may not be UWB. The first locating interface 308 may be configured for one-directional communication with at least one beacon (e.g., receiving). The first locating interface 308 is configured to provide first locating data, which includes one or more of a unique identifier (such as a username), a device air level, a device battery level, one or more antenna set identifiers, and one or more capability indicators. The accuracy of tracking for the first locating interface 308 may be on the order of meters.

The unique identifier may include a username, MAC address, or other identifier associated with the support device (e.g., SCBA). The unique identifier may be user configurable. The unique identifier from the first locating interface 308 may be used to associate with other data received by the other locating interfaces. For example, packet data from another locating interface may be associated with a second unique identifier and may be matched with packet data from the first locating interface having a first unique identifier that matches the second unique identifier. In this manner, packet data across multiple locating interfaces may be matched and associated.

The device air level may indicate how much air an individual wearing the beacon has available. The device battery level may indicate how much battery life is left for the support device. Such level information may be used to make search decisions, such as prioritizing among multiple beacons.

The one or more antenna set identifiers may indicate on which antenna set the first locating data was received by the locating device 300. This data may be used, for example, to determine a direction tracking parameter.

The capability indicators may include binary values, or flags, indicating whether the wearable beacon is capable of transmitting different types of locating signals. In some embodiments, the one or more capability indicators include a BLUETOOTH AoA flag, UWB flag, and a MCPD flag.

In some embodiments, the preliminary directional information generally constitutes a coarse bearing on the wearable beacon's position, which the locating device acquires via its first locating interface. This extended-coverage communication protocol, often capable of operation at greater distances or with broader spatial reach, provides an initial estimate of the beacon's direction. For example, the first locating interface may detect variations in signal strength or leverage multiple antenna sets to determine an approximate quadrant or heading where the beacon is located. Although this information may not pinpoint the exact orientation or distance, it offers a foundational indication of where the beacon resides within the environment, thereby assisting the device in guiding subsequent, more precise range and directional measurements.

The second locating interface 310 may be configured with a communications protocol that conforms to the IEEE 802.15.4z standard having UWB. The signals received or transmitted by the second locating interface 310 may have a center frequency between 6 GHz and 10 GHz. The second locating interface 310 may be configured to establish bidirectional communication with at least one beacon. The second locating interface 310 is configured to provide second locating data, which may include a UWB ranging parameter. The UWB ranging parameter may be processed, for example, by the processing circuitry 304 to provide a range tracking parameter or to be used as an input to determine a range tracking parameter. The accuracy of the second locating interface 310 may be on the order of centimeters. In some embodiments, the “range tracking parameter” refers to a quantitative measure that indicates how far the wearable beacon is from the locating device at a given moment. It can be derived through various distance measurement methods-such as evaluating phase differences across multiple frequencies, measuring the time-of-flight of transmitted signals, or analyzing round-trip timing data. By numerically representing the approximate or actual separation between the beacon and the locating device, the range tracking parameter forms a key component of the localization process, especially when combined with directional measurements from other interfaces.

In certain embodiments, the second locating interface is configured to perform a Bluetooth®-based distance measurement procedure, leveraging multi-carrier phase difference or round-trip timing to determine a range tracking parameter for the wearable beacon. One commercially available example of this approach is the Nordic Distance Toolbox (NDT) from Nordic Semiconductor, headquartered in Trondheim, Norway, which allows for refined distance estimation by evaluating phase slopes across multiple frequencies, as well as by analyzing timing exchanges between the locating device and the beacon.

By integrating NDT with additional filtering or error-correction algorithms, the second locating interface can adapt to environmental factors such as multipath interference, variable signal strength, or obstacles in the operational field. Furthermore, the use of Bluetooth® protocols in concert with multi-carrier phase difference or round-trip timing methods allows for robust short-range distance measurement; when combined with directional data from other locating interfaces, it enables precise overall localization of the wearable beacon.

In certain embodiments, the locating device employs the second locating interface to determine a range tracking parameter for the wearable beacon by utilizing short-range distance measurement techniques. This interface may rely on multi-carrier phase difference (MCPD) analysis, in which signal phase shifts are evaluated across multiple frequency channels, or round-trip timing (RTT) approaches that measure time intervals between signal transmissions and receptions. Alternatively, time-of-flight (ToF) calculations can be executed, tracking how long it takes a signal to travel between the locating device and the beacon. These different methodologies, used singly or in combination, yield accurate distance estimations even in various environmental conditions where other forms of signal measurement may degrade.

Additionally, the second locating interface may incorporate error-correction and filtering algorithms to enhance measurement reliability. For instance, the interface could collate multiple concurrent distance estimates—derived from varying frequencies or repeated measurements—to account for transient signal interruptions or multipath reflections. Outlier data points that exceed predefined statistical bounds might be temporarily excluded or flagged for further validation, ensuring that the reported range represents the most probable distance between the locating device and the beacon at any given time.

Once the range tracking parameter is established, the locating device's controller can fuse it with directional inputs received through the other interfaces. The refined directional parameter available from the wideband-based third locating interface, when combined with the second locating interface's short-range distance data, supports a cohesive view of the beacon's position. This real-time synthesis facilitates clear, actionable insight into both how far away the beacon is and in which direction it lies.

The third locating interface 312 may be configured with a communications protocol that conforms to the BLUETOOTH AoA protocol. The signals received by the third locating interface 312 may have a center frequency of 2.4 GHz. The third locating interface 312 may be configured to establish one-directional communication with at least one beacon (e.g., receiving). The third locating interface 312 provides third locating data, which may include a constant tone extension (CTE) parameter. The CTE parameter may be processed, for example, by the processing circuitry 304 to provide a direction tracking parameter or to be used as an input to determine a direction tracking parameter, for example, as an input into a sensor fusion to determine a direction tracking parameter. The accuracy of the third locating interface 312 may be on the order of meters. The effective range of the third locating interface 312 may be less than the effective range of the first locating interface 308 but similar to the effective range of the second locating interface 310.

In certain embodiments, the third locating interface employs a wideband communication protocol, a term that, as used herein, encompasses technologies operating over a relatively broad swath of the radio spectrum, including ultra-wideband (UWB) systems. By leveraging an extended frequency range, such interfaces can capture highly detailed signal variations—such as minute phase shifts, angle-of-arrival (AoA) data, or timing metrics—that enable a more precise directional measurement of the wearable beacon. This design refines the preliminary directional information provided by the first locating interface into a refined directional parameter, yielding greater localization accuracy in challenging environments prone to reflections or interference.

Additionally, the third locating interface may use advanced signal processing algorithms to interpret the multiple frequencies or sub-bands within its operational scope, correlating subtle shifts in signal amplitude and timing to pinpoint small angular increments. Such detailed analysis transforms an approximate bearing into a refined directional parameter that can resolve the beacon's orientation with minimal error, far beyond what narrower-band protocols might achieve. This enhanced directionality is particularly beneficial when other objects or structural features in the environment would otherwise complicate a simpler direction-finding approach.

Moreover, the locating device's controller fuses the wideband-based directional data from the third locating interface with the extended-range directional cues acquired by the first locating interface. Through comparison, validation, and outlier filtering, the system converges on a consistent directional result that captures both high-level bearing and highly granular angular detail. When combined with the distance data derived from the second locating interface, this refined directional parameter improves the speed and precision of beacon tracking, enabling the locating device to react swiftly and effectively in emergency or time-sensitive scenarios.

In some embodiments, the locating device's controller may combine the refined directional parameter—which pinpoints the beacon's orientation relative to the device—with the range tracking parameter, which indicates the beacon's estimated distance. By synchronizing these data points within a unified coordinate framework, the system infers the beacon's location in a more precise manner than would be possible using either measurement alone. For instance, the controller may overlay distance readings on the directional axis, verifying consistency between the two and applying outlier filtering if discrepancies arise. This fusion of direction and distance allows the device to plot the beacon's position on a user interface or map, creating a consolidated “location result” that better illustrates both how far away the beacon is and the path needed to reach it.

The fourth locating interface 314 may be configured with a communications protocol that conforms to an MCPD protocol. The signals received by the fourth locating interface 314 may have a center frequency of 2.4 GHz. The fourth locating interface 314 may be configured to establish bidirectional communication with at least one beacon. The fourth locating interface 314 provides fourth locating data, which may include a phase-based ranging parameter. The phase-based ranging parameter may be processed, for example, by the processing circuitry 304 to provide a range tracking parameter or to be used as an input to determine a range tracking parameter. The accuracy of the fourth locating interface 314 may be on the order of meters or centimeters. The effective range of the fourth locating interface 314 may be less than the first locating interface 308, greater than the second locating interface 310, and greater than the third locating interface 312.

In some embodiments, the first locating interface 308 has a limited packet size and thus a limited amount of data that may be transmitted in each packet. Additional information may be transferred using other locating interfaces, which may have larger packet sizes. In some embodiments, at least one of the second locating data, the third locating data, the fourth locating data, or any combination of these, is configured to provide additional data that is not provided in the first locating data. One or more of the second locating data, third locating data, or fourth locating data may include a unique identifier, one or more of a biometric parameter and an environmental parameter.

As discussed before, the unique identifier provided by the second, third, or fourth locating interface may be used to match packet data. Accordingly, the unique identifier may be described as a second unique identifier, third unique identifier, or fourth unique identifier depending on the locating interface.

Biometric parameters may include one or more of core temperature, blood oxygenation, heart rate, blood pressure, or breathing rate (e.g., respiration rate). These parameters may be measured by any suitable biometric sensor operably connected to the wearable beacon. In some embodiments, the one or more biometric parameters includes a breathing rate. Among other uses, biometric parameters may be used to make search decisions, such as prioritizing among multiple beacons. For example, each biometric parameter or particular combination of biometric parameters may have a predetermined envelope, such as a range, of values. These values may be predetermined or user configurable. When the one or more biometric parameters falls outside, or exceeds, the envelope, the individual may be prioritized for search and rescue.

Environmental parameters may include a gas detection parameter (e.g., for carbon dioxide, oxygen, hydrogen sulfide, etc.), an altimeter parameter, or an environmental temperature parameter. One or more of these parameters may be received from the wearable support device. Environmental parameters, in particular, may be determined as composite or derived values based on one or more measurements (e.g., an average or a first, second, or third-order derivative over time). Among other uses, environmental parameters may be used to make search decisions, such as prioritizing among multiple beacons.

The parameters, or data elements, of the present disclosure may be measured or derived in any suitable manner. For example, a parameter may be measured over time, a mathematical operation may be performed, such as a derivative, etc. In general, a person of ordinary skill in the art having the benefit of the present disclosure may use any suitable technique available to interpret each parameter.

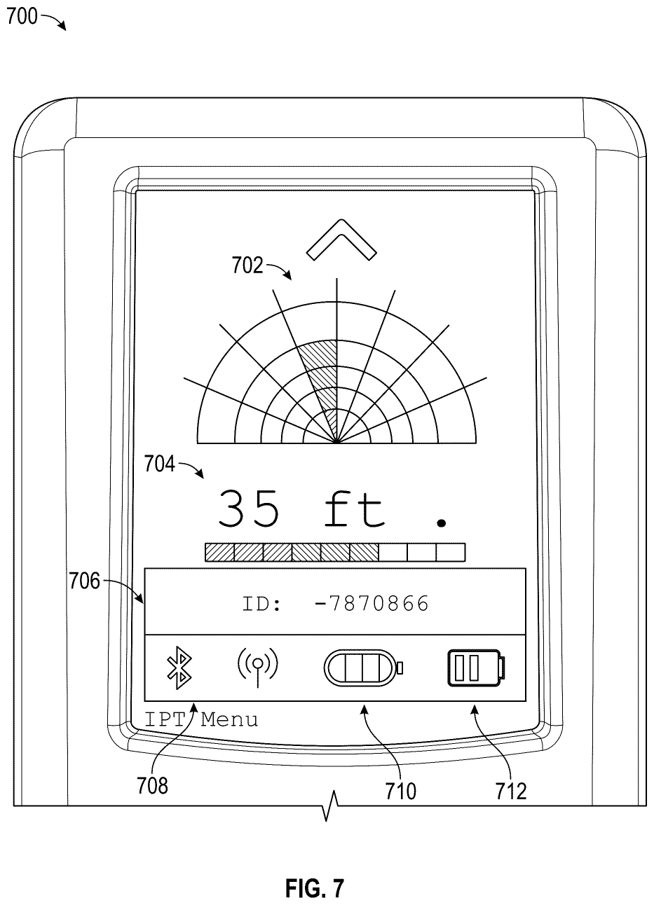

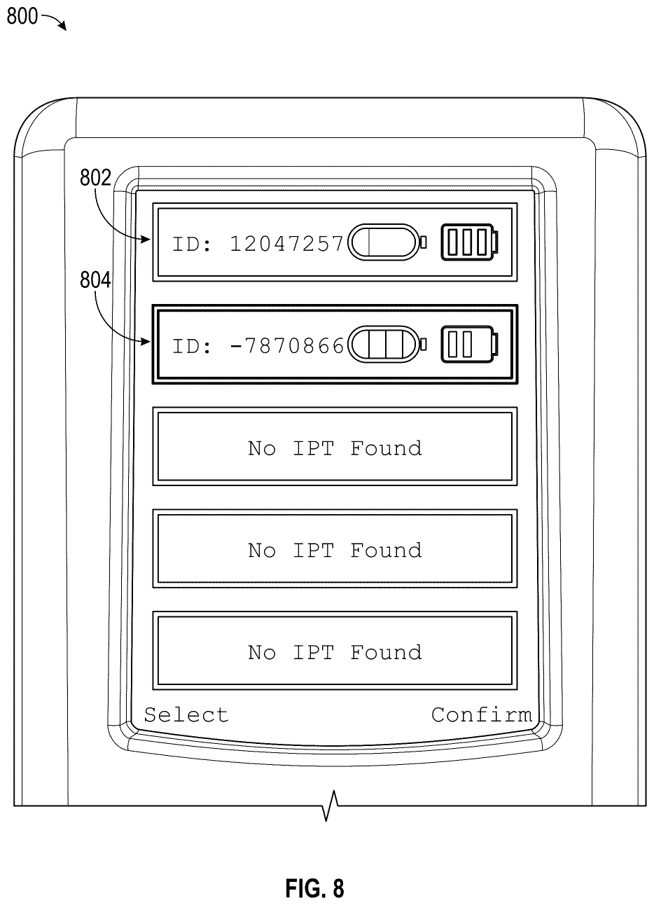

The controller 302 may also be operably coupled to a user interface 316, which may be the user interface 202 of FIG. 2. The user interface 316 may be used to display an indication of at least one of a range to a wearable beacon based on a range tracking parameter, a direction to a wearable beacon based on a direction tracking parameter, or both. Other indications may be provided based on other parameters in the locating data, such as a battery level percentage indicator based on a device battery level parameter or an air level pounds per square inch (PSI) indicator based on a device air level parameter. Some example uses of the user interface 316 are shown and described with respect to FIG. 7 and FIG. 8.

The locating device 300 may also include a wireless communication interface 318 operably coupled to the controller 302. The wireless communication interface 318 may be configured to transmit or receive search data with at least one other on-site devices if available. In some embodiments, the wireless communication interface may not be used to directly communicate with the wearable support device. In general, the locating device 200 may include communication interfaces that may not communicate directly with the wearable support device and locating interfaces that are configured to communicate directly with the wearable support device. Other on-site devices may include other locating devices or an IC device. The search data may include various data useful in facilitating the search including locating data from other devices.

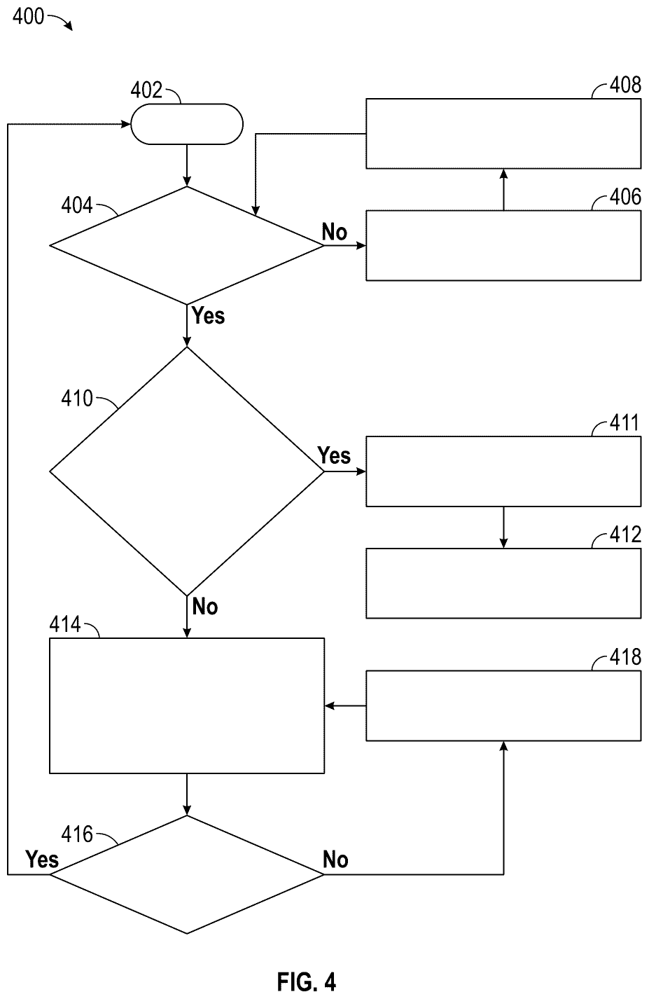

FIG. 4 is a flow diagram of a locating method 400 usable with the locating device 104 of FIG. 1, the locating device 200 of FIG. 2, or the locating device 300 of FIG. 3. The method 400 may start at block 402 with powering on the locating device. Some of all of the method 400 may be carried out by the controller of the locating device. Processing circuitry of the controller may be configured to carry out one or more of the blocks of the method 400.

At block 404, the method 400 may include determining whether the user of the locating device has started a search for one or more beacons in an alarm state. If the user has not started searching, the method 400 may continue to monitoring the first locating interface for first locating data in block 404.

In block 408, if multiple beacons are identified based on the first locating data, a priority beacon may be selected or the beacons may be ordered by priority by the locating device, which may include user input. In some embodiments, the locating device may receive a set of first locating data associated with a plurality of wearable beacons. The locating device may then determine a priority order of the plurality of wearable beacons based on at least the set of first locating data. The prioritizing of beacons may be based parameters, such as a device air level (e.g., lowest remaining air level) or a device battery level (e.g., lowest battery level). The selection of parameters to determine the priority may be user configurable. In some embodiments, additional parameters may be used to determine the priority order of the beacons, such as locating data from other interfaces, a predicted remaining air parameter (e.g., predicted to run out of air first), a range tracking parameter (e.g., closest in distance), and a basic tracking parameter (e.g., closest in distance), among others. The predicted remaining air may be determined based on device air level from the first locating data and breathing rate based on other locating data.

In some embodiments, a priority order of a plurality of wearable beacons may be determined based on at least a set of first locating data from the plurality of wearable beacons and search data. The use of search data from other locating devices or the IC device may facilitate efficiently assigning locating devices when multiple beacons are in an alarm state, for example, such that each locating device prioritizes a different beacon for search. Bidirectional communication with other locating devices and/or the IC device may facilitate such efficiency.

The method 400 may return to determining whether the user has started a search for one or more beacons in block 404.

If the user has started searching in response to block 404, the method 400 may continue in block 410 to determine whether the beacon is capable of advanced communications. The beacon may be the selected, or prioritized, beacon as determined in block 408. In some embodiments, advanced communications may include determining whether the beacon is capable of transmitting at least three different locating signals. In some embodiments, advanced communications may include determining whether the beacon is capable of bidirectional communication with the locating device. The bidirectional communication, for example, may be used to send packets back to the beacon, or wearable support device, to facilitate direction tracking, range tracking, or both, and optionally so that the individual associated with the alarm state is informed or other searchers are informed of the search status.

If the beacon is capable of advanced communications in block 410, the method 400 may continue to initiate a range tracking routine in block 411, to initiate a direction tracking routine in block 412, or both. The tracking routines use at least one of a second, third, and fourth locating interface. The range tracking routine is configured to provide range tracking parameter indicative of a range between the locating device and the selected beacon. The direction tracking routine is configured to provide a direction tracking parameter indicative of a direction of the selected beacon from the orientation of the locating device. The tracking routines may continue until the beacon has been found. In general, the beacon may be found when the alarm state from the beacon has been disabled, which may signal that the beacon has been found. In one example, the user may need to physically disable the alarm state on the wearable support device. Other conditions for finding the beacon may also be used to determine whether the beacon has been found, such as a comparison of the tracking range parameter with a threshold range (e.g., within a meter).

On the other hand, if the beacon is not capable of advanced communications in block 410, the method 400 may continue to initiate a basic tracking routine in block 414. The basic tracking routine may include using only first locating interface. The basic tracking routine is configured to provide a basic tracking parameter based on the first locating data. The basic tracking parameter may provide an indication of direction and optionally an indication of range. The first locating interface may include use of multiple antenna sets. In one example, the first locating interface includes three antenna sets. No sweeping motion may be requested, or required, of the user to provide the basic tracking parameter, particularly when multiple antenna sets are used.

At block 416, the method 400 may determine whether the selected beacon has been found. If the selected beacon has not been found, the method 400 may continue to monitor the first locating interface in block 418 and continue to run the basic tracking routine in block 414. On the other hand, if the beacon has been found, the method 400 may return to block 402.

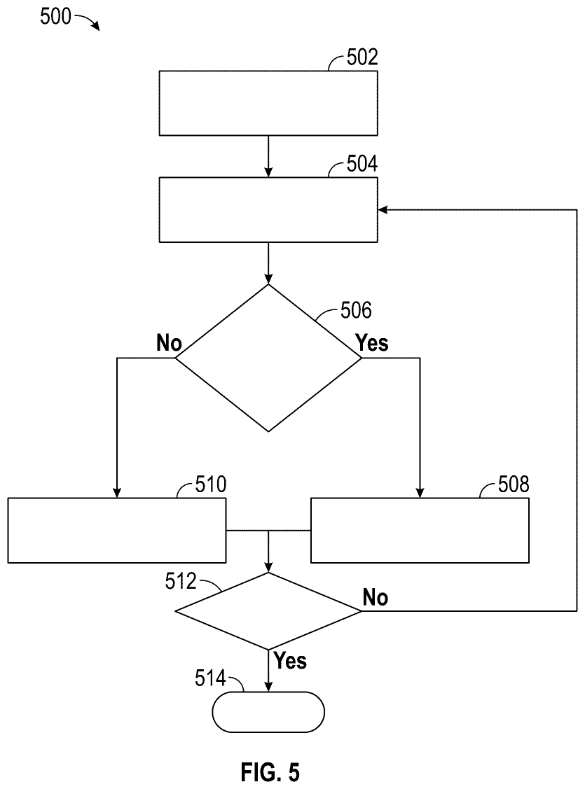

FIG. 5 is a flow diagram of one example of a range tracking method 500 usable as the range tracking routine 411 of FIG. 4. The method 500 includes initiating the range tracking routine in block 502. At least one locating interface, other than the first locating interface, may be monitored in block 504. In some embodiments, a second locating interface and a fourth locating interface may be monitored for second and fourth locating data, respectively.

At block 506, the method 500 may determine whether locating data from a selected locating interface is consistent. Consistency may be determined in any suitable manner. In one example, if at least a threshold number of packets is received by the locating interface from a particular beacon over a predetermined period of time, then the locating data from the locating interface is consistent. If the locating data from the selected locating interface is consistent, the method 500 continues to determining a range tracking parameter based on at least this locating data in block 508. An indication of range to the selected beacon may also be provided on a user interface based on the range tracking parameter.

If the locating data from the selected interface is not consistent, the method 500 continues to determining a range tracking parameter based on other locating data from another locating interface in block 510. An indication of range to the selected beacon may also be provided on a user interface based on the range tracking parameter.

In some embodiments, if the second locating data from the second locating interface using a communications protocol conforming to the IEEE 802.15.4z standard having UWB is consistent, the range tracking parameter is determined based on the second locating data. Otherwise, the range tracking parameter is determined based on the fourth locating data from the fourth locating interface determined based on an MCPD protocol. In other words, the range tracking parameter may be determined in response to the second locating data being consistent or not, and the range tracking parameter may be determined based on the second locating data or the fourth locating data. This configuration may be particularly advantageous for taking advantage of the various strengths of each protocol. For example, the communications protocol confirming to the IEEE 802.15.4z standard having UWB may have a shorter effective range than the MCPD protocol but greater accuracy, so it is preferred unless it is inconsistent.

At block 512, the method 500 may determine whether the beacon has been found. If the beacon has not been found, the method 500 may return to monitoring at least one locating interface other than the first locating interface in block 504. If the beacon has been found, the method 500 may exit the range tracking routine in block 514. The method 500 may return to block 402 of the method 400 of FIG. 4.

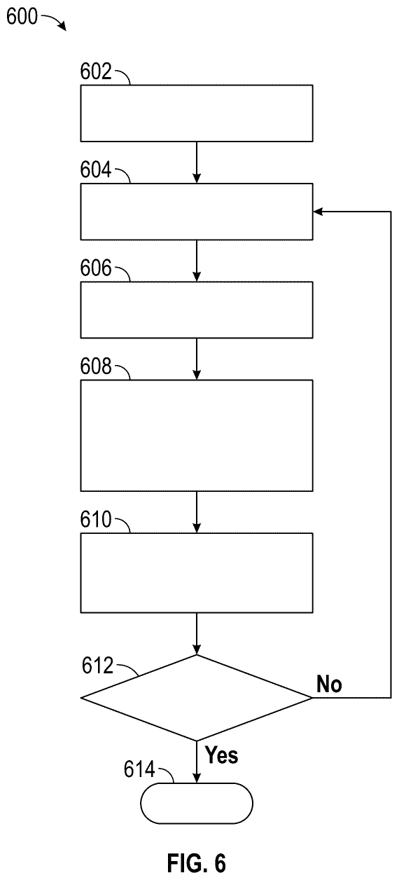

FIG. 6 is a flow diagram of one example of a direction tracking method 600 usable as the direction tracking routine 412 of FIG. 4. The method 600 includes initiating the direction tracking routine in block 602. The first locating interface is monitored in block 604 and at least one other locating interface is monitored in block 606. In some embodiments, the third locating interface conforming to the BLUETOOTH AoA protocol is monitored.

In block 608, the locating data from both interfaces is combined to provide a direction tracking parameter. In some embodiments, the combined locating data is from the first locating data and third locating data. The combination of locating data may be described as sensor fusion. The direction tracking parameter may be described as representing a vector from the locating device toward the selected beacon.

In some embodiments, the direction tracking parameter may be determined based on a comparison of the first unique identifier and a second unique identifier from the third locating data. The unique identifiers may be matched to associate packet data from the first and third locating data as being from the same beacon.

An indication of the direction tracking parameter may be provided to a user interface in block 610. The direction tracking parameter may provide an indication of direction in a horizontal plane, or both directions in a horizontal plane and in vertical plane. In some embodiments, the indication may combine both horizontal and vertical directions into a single visual indication.

At block 612, the method 600 may determine whether the beacon has been found. If the beacon has not been found, the method 600 may return to monitoring the locating interfaces in block 604. If the beacon has been found, the method 600 may exit the direction tracking routine in block 614. The method 600 may return to block 402 of the method 400 of FIG. 4.

FIG. 7 is a view of a one example of an interface configuration 700 usable with the user interface of the locating device 104 of FIG. 1 for indicating range, direction, or both of a wearable beacon. The user interface may be a graphical display configured to display one or more visual representations, elements, or indications of various parameters. The interface configuration 700 may include an indication 702 of the direction tracking parameter showing a radar graph that highlights an arc segment, and optionally also provides an indication of the range tracking parameter by highlighting a number of range segments extending from the origin of the radar graph. The radar graph shows a direction in a two-dimensional plane from the locating device. In other embodiments (not shown), the interface configuration 700 may also include a indication of upward or downward directions as part of the direction tracking parameter.

The interface configuration 700 may include an indication 704 of the range tracking parameter, which may represent the range tracking parameter in a different form (e.g., text and bar graph) than the indication 702.

Other indications may also be provided in the interface configuration 700, for example of other parameters from the locating data. The indication 708 shows different types of locating interfaces being monitored by the locating device to track the beacon. The indication 710 shows a device air level of the support device operably coupled to the beacon. The indication 712 shows a device battery level of the support device operably coupled to or including the beacon.

FIG. 8 shows one example of an interface configuration 800 usable with the user interface of the locating device 104 of FIG. 1 for prioritizing wearable beacons usable with the locating device 104 of FIG. 1. The interface configuration 800 may include indications of one or more beacons and a list of the beacons, which may be used to select a priority beacon or to provide an order of priority of the beacons for the locating device. In the illustrated example, the interface configuration 800 shows an indication 802 of a first beacon and an indication of a second beacon 804. In some embodiments, the user may be able to select one of the beacons to prioritize for searching. The indication for each beacon may include various information, such as one or more of a unique identifier, a device air level, and a device battery level.

In some embodiments, in response to the user making a selection of the priority beacon, the locating device may utilize bidirectional communication through one of the locating interfaces to send search data to the beacon. Such search data may indicate to the individual wearing the beacon that a locating device, or this particular locating device, is searching for this beacon. In some embodiments, the locating device may provide a suggested order of priority or suggested priority beacon, which may be based on locating data, additional data, or search data.

Thus, various embodiments of MULTI-PROTOCOL FIREFIGHTER LOCATING are disclosed. Other features and combinations of features within the scope of this disclosure may be readily apparent to one skilled in the art having the benefit of the figures, descriptions, and claims.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer). A hardware-based processing unit may include one or more processors. The term “processor” as used herein may refer to a physical structure suitable for implementation of functionality described herein, such as the execution of instructions or code, and may include one or more digital signal processors (DSPs), general purpose microprocessors, application specific integrated circuits (ASICs), field programmable logic arrays (FPGAs), or other equivalent integrated or discrete logic circuits or logic elements.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be replaced to “couplable” or “connectable” to describe that the elements are configured to be coupled or connected. In addition, either term may be modified by “operatively” and “operably,” which may be used interchangeably, to describe that the coupling or connection is configured to allow the components to interact to carry out functionality.

As used herein, the term “configured to” may be used interchangeably with the terms “adapted to” or “structured to” unless the content of this disclosure clearly dictates otherwise.

The singular forms “a,” “an,” and “the” encompass embodiments having plural referents unless its context clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

### LIST OF ILLUSTRATIVE EMBODIMENTS

### Embodiment 1

A locating device comprising:
a first locating interface configured to receive a first locating signal over a first communication protocol and provide first locating data;
a second locating interface configured to receive a second locating signal over a second communication protocol different than the first communication protocol and provide second locating data;
a third locating interface configured to receive a third locating signal over a third communication protocol different than the first and second communication protocols and provide third locating data; and
a controller operably coupled to the first locating interface, the second locating interface, and the third locating interface, the controller comprising processing circuitry and memory, the controller configured to:
monitor the first locating interface for the first locating data;
in response to receiving the first locating data comprising a first unique identifier of a wearable beacon, determine whether the wearable beacon is capable of transmitting at least three different locating signals based on at least the first locating data;
in response to determining that the wearable beacon is capable of transmitting at least three different locating signals, initiate a range tracking routine, a direction tracking routine, or both;
in response to initiating the range tracking routine, determine a range tracking parameter in response to the second locating data; and
in response to initiating the direction tracking routine, determine a direction tracking parameter based on at least the first locating data and the third locating data.

### Embodiment 2

The locating device of Embodiment 1, wherein the first locating data has a first packet size, the second locating data has a second packet size greater than the first packet size, and the third locating data has a third packet size greater than the first packet size.

### Embodiment 3

The locating device of according to any preceding embodiment, wherein the wearable beacon has bidirectional communication capability, and the controller is configured to establish bidirectional communication with the wearable beacon to receive the second locating data in response to initiating the range tracking routine.

### Embodiment 4

The locating device of according to any preceding embodiment, wherein the controller is further configured to:
in response to determining that the wearable beacon is not capable of transmitting at least three different locating signals, initiate a basic tracking routine; and
in response to initiating the basic tracking routine, determine a basic tracking parameter based on the first locating data.

### Embodiment 5

The locating device of according to any preceding embodiment, wherein the first locating data comprises data from at least three different sets of antenna.

### Embodiment 6

The locating device according to any preceding embodiment, wherein the first communication protocol has a first packet size, the second communication protocol has a second packet size larger than the first packet size, and the third communication protocol has a packet size larger than the first packet size.

### Embodiment 7

The locating device according to any preceding embodiment, wherein the first locating data comprises at least one of a username, a device air level, a device battery level, one or more antenna set identifiers, and one or more capability indicators.

### Embodiment 8

The locating device according to any preceding embodiment, wherein the second locating data, the third locating data, or both comprise at least one of a unique identifier, a biometric parameter, and an environmental parameter.

### Embodiment 9

The locating device according to any preceding embodiment, wherein the first communication protocol conforms to the IEEE 802.15.4 standard having a center frequency of 2.4 GHz.

### Embodiment 10

The locating device according to any preceding embodiment, wherein the second communication protocol conforms to the IEEE 802.15.4z standard having an ultrawide bandwidth and a center frequency between 6 GHz and 10 GHz.

### Embodiment 11

The locating device according to any preceding embodiment, wherein the third communication protocol conforms to the BLUETOOTH AoA protocol having a center frequency of 2.4 GHZ, and the third locating data comprises a constant tone extension parameter.

### Embodiment 12

The locating device according to any preceding embodiment, further comprising a fourth locating interface configured to receive a fourth locating signal over a fourth communication protocol different than the first, second, and third communication protocols and provide fourth locating data having a fourth packet size greater than the first packet size: wherein the controller is further configured to determine the range tracking parameter based on at least one of the second locating data and the fourth locating data.

### Embodiment 13

The locating device of Embodiment 12, wherein the fourth locating data is determined based on a Multi-Carrier Phase Difference (MCPD) protocol and the fourth locating signal has a center frequency of 2.4 GHz.

### Embodiment 14

The locating device according to any preceding embodiment, wherein the controller is further configured to determine the direction tracking parameter in response to a comparison of the first unique identifier and a second unique identifier from the third locating data.

### Embodiment 15

The locating device according to any preceding embodiment, wherein the first communication protocol has a first effective range in a nominal environment and the second communication protocol has a second effective range in the nominal environment less than the first effective range.

### Embodiment 16

The locating device according to any preceding embodiment, further comprising a user interface, wherein the controller is further configured to provide an indication of at least one of a range to the wearable beacon based on at least the range tracking parameter, a direction to the wearable beacon based on at least the direction tracking parameter, or both.

### Embodiment 17

The locating device according to any preceding embodiment, wherein the locating device is a handheld device.

### Embodiment 18

The locating device according to any preceding embodiment, wherein the controller is further configured to:
receive a set of first locating data associated with a plurality of wearable beacons; and
determine a priority order of the plurality of wearable beacons based on at least the set of first locating data.

### Embodiment 19

The locating device of according to any preceding embodiment, further comprising a wireless communication interface configured to transmit or receive search data with another on-site device, wherein the controller is further configured to determine the priority order of the plurality of wearable beacons based on at least the set of first locating data and the search data.

### Embodiment 20

A method for using a locating device, the method comprising:
monitoring a first locating interface of the locating device for first locating data;
in response to receiving the first locating data comprising a first unique identifier of a wearable beacon, determining whether the wearable beacon is capable of transmitting at least three different locating signals based on at least the first locating data;
in response to determining that the wearable beacon is capable of transmitting at least three different locating signals, initiating a range tracking routine, a direction tracking routine, or both;
in response to initiating the range tracking routine, determining a range tracking parameter in response to second locating data from the wearable beacon; and
in response to initiating the direction tracking routine, determining a direction tracking parameter based on at least the first locating data and third locating data from the wearable beacon.

### Embodiment 21

The method of Embodiment 20, wherein the first locating data has a first packet size, the second locating data has a second packet size greater than the first packet size, and the third locating data has a third packet size greater than the first packet size.

### Embodiment 22

The method of according to any preceding embodiment, wherein the wearable beacon has bidirectional communication capability, and the controller is configured to establish bidirectional communication with the wearable beacon to receive the second locating data in response to initiating the range tracking routine.

### Embodiment 23

A system comprising:
a wearable beacon configured to transmit at least three different locating signals each over a different communication protocol; and
the locating device of any one of Embodiments 1 through 17.

### Embodiment 24

A method for using a locating device in an environment, the locating device including at least one controller operably coupled to a first locating interface configured with an extended coverage communication protocol, a second locating interface configured for short-range distance measurement, and a third locating interface configured with a wideband communication protocol, the method comprising:
obtaining, via the first locating interface, preliminary directional information from a wearable beacon;
refining the preliminary directional information into a refined directional parameter by using the third locating interface;
determining a range tracking parameter for the wearable beacon using the second locating interface;
integrating the refined directional parameter and the range tracking parameter to generate a location result for the wearable beacon; and
providing the location result to at least one user interface accessible by the locating device.

### Embodiment 25

The method of Embodiment 24, wherein the extended coverage communication protocol used by the first locating interface is a Zigbee-based protocol and operates under an IEEE 802.15.4 standard.

### Embodiment 26

The method of according to any preceding embodiment, wherein the second locating interface employs at least one of multi-carrier phase difference, round-trip timing, or time-of-flight measurements to generate the range tracking parameter.

### Embodiment 27

The method of according to any preceding embodiment, wherein the third locating interface utilizes a wideband communication approach configured to resolve phase or angle-of-arrival information to refine the directional parameter of the wearable beacon.

### Embodiment 28

The method of according to any preceding embodiment, further comprising comparing multiple measurement outputs for either the direction or the range, applying outlier filtering routines, and selecting a measurement output that satisfies a predefined accuracy threshold.

### Embodiment 29

The method of according to any preceding embodiment, further comprising graphically displaying, via the at least one user interface, an indication of the refined directional parameter and an indication of the range tracking parameter in a combined visualization.

### Embodiment 30

The method of according to any preceding embodiment, further comprising adjusting a transmit power or frequency parameter of at least one locating interface based on real-time signal metrics observed from the wearable beacon.

### Embodiment 31

The method of according to any preceding embodiment, further comprising recording the location result in a data log accessible to a command center device, thereby permitting post-incident analysis or review of the wearable beacon's positions over time.

### Embodiment 32

The method of according to any preceding embodiment, further comprising receiving, from the wearable beacon, one or more sensor readings selected from a device air level or a device battery level and including such readings in the location result provided to the at least one user interface.

### Embodiment 33

The method of according to any preceding embodiment, further comprising receiving, from the first locating interface, a media access control (MAC) address associated with the third locating interface.

### Embodiment 34

A system comprising:
a locating device having at least one controller with processing circuitry and memory, the locating device further comprising:
a first locating interface configured with an extended coverage communication protocol to obtain preliminary directional information from a wearable beacon;
a second locating interface configured for short-range distance measurement to determine a range tracking parameter for the wearable beacon; and
a third locating interface configured with a wideband communication protocol to refine directional information;
wherein the at least one controller is configured to:
acquire the preliminary directional information of the wearable beacon via the first locating interface,
refine the preliminary directional information into a refined directional parameter by using the third locating interface,
determine the range tracking parameter using the second locating interface,
integrate the refined directional parameter and the range tracking parameter to generate a location result for the wearable beacon, and
provide the location result to at least one user interface of the locating device.

### Embodiment 35

The system of Embodiment 34, wherein the first locating interface is implemented under a Zigbee-based protocol operating in compliance with an IEEE 802.15.4 standard, and the second locating interface uses multi-carrier phase difference or round-trip timing measurements for short-range distance measurement.

### Embodiment 36

The system of according to any preceding embodiment, further comprising computer-executable instructions stored in the memory that, when executed by the at least one controller, implement an outlier filtering routine on measurements from the second or third locating interfaces, enforce a secure communication protocol for data exchange, or both.

### Embodiment 37

The system of according to any preceding embodiment, further comprising computer-readable instructions stored in the memory that, when executed by the at least one controller, implement an outlier filtering algorithm on measurements received from the second locating interface or the third locating interface to improve accuracy of the location result.

### Embodiment 38

The system of according to any preceding embodiment, wherein the second locating interface is configured to employ a Bluetooth®-based distance measurement procedure, including multi-carrier phase difference or round-trip timing, for generating the range tracking parameter.

### Embodiment 39

The system of according to any preceding embodiment, wherein the third locating interface utilizes an ultra-wideband (UWB) protocol to obtain signal measurements with expanded frequency coverage, enabling finer resolution of the refined directional parameter.

### Embodiment 40

The system of according to any preceding embodiment, further comprising a communications module configured to broadcast a media access control (MAC) address associated with the third locating interface, wherein the at least one controller is further configured to receive, via the first locating interface, status updates related to that MAC address.

### Embodiment 41

The system of according to any preceding embodiment, wherein the locating device is adapted for use in an immediately dangerous to life or health (IDLH) environment, and the at least one user interface is designed to present the location result with high-contrast visual cues for rapid identification of the wearable beacon.

### Embodiment 42

The system of according to any preceding embodiment, further comprising a logging module operably coupled to the at least one controller, wherein the logging module is configured to store successive location results in a data log for subsequent analysis by a command center or other authorized operators.

### Embodiment 43

The system of according to any preceding embodiment, wherein the locating device is configured to receive from the wearable beacon at least one biometric or environmental sensor reading and associate that reading with the location

What is claimed is:

1. A locating device comprising:
a first locating interface configured to receive a first locating signal over a first communication protocol and provide first locating data;
a second locating interface configured to receive a second locating signal over a second communication protocol different than the first communication protocol and provide second locating data;
a third locating interface configured to receive a third locating signal over a third communication protocol different than the first and second communication protocols and provide third locating data; and
a controller operably coupled to the first locating interface, the second locating interface, and the third locating interface, the controller comprising processing circuitry and memory, the controller configured to:
monitor the first locating interface for the first locating data;
in response to receiving the first locating data comprising a first unique identifier of a wearable beacon, determine whether the wearable beacon is capable of transmitting at least three different locating signals based on at least the first locating data;
in response to determining that the wearable beacon is capable of transmitting at least three different locating signals, initiate a range tracking routine, a direction tracking routine, or both;
in response to initiating the range tracking routine, determine a range tracking parameter in response to the second locating data; and
in response to initiating the direction tracking routine, determine a direction tracking parameter based on at least the first locating data and the third locating data.

2. The locating device of claim 1, wherein the first locating data has a first packet size, the second locating data has a second packet size greater than the first packet size, the third locating data has a third packet size greater than the first packet size.

3. The locating device of claim 1, wherein the wearable beacon has bidirectional communication capability, wherein the controller is configured to establish bidirectional communication with the wearable beacon to receive the second locating data in response to initiating the range tracking routine.

4. The locating device of claim 1, wherein the controller is further configured to:
in response to determining that the wearable beacon is not capable of transmitting at least three different locating signals, initiate a basic tracking routine; and
in response to initiating the basic tracking routine, determine a basic tracking parameter based on the first locating data.

5. The locating device of claim 4, wherein the first locating data comprises data from at least three different sets of antenna.

6. The locating device according to claim 1, wherein the first locating data comprises at least one of a username, a device air level, a device battery level, one or more antenna set identifiers, and one or more capability indicators.

7. The locating device according to claim 6, wherein the second locating data, the third locating data, or both comprise at least one of a unique identifier, a biometric parameter, and an environmental parameter.

8. The locating device according to claim 1, wherein the first communication protocol conforms to the IEEE 802.15.4 standard having a center frequency of 2.4 GHz.

9. The locating device according to claim 1, wherein the second communication protocol conforms to the IEEE 802.15.4z standard having an ultrawide bandwidth and a center frequency between 6 Ghz and 10 Ghz.

10. The locating device according to claim 1, wherein the third communication protocol conforms to the BLUETOOTH AoA protocol having a center frequency of 2.4 GHz and the third locating data comprises a constant tone extension parameter.

11. The locating device according to claim 1, further comprising a fourth locating interface configured to receive a fourth locating signal over a fourth communication protocol different than the first, second, and third communication protocols and provide fourth locating data having a fourth packet size greater than the first packet size; wherein the controller is further configured to determine the range tracking parameter based on at least one of the second locating data and the fourth locating data.

12. The locating device according to claim 11, wherein the fourth locating data is determined based on a Multi-Carrier Phase Difference (MCPD) protocol and the fourth locating signal has a center frequency of 2.4 GHz.

13. The locating device according to claim 1, wherein the controller is further configured to determine the direction tracking parameter in response to a comparison of the first unique identifier and a second unique identifier from the third locating data.

14. The locating device according to claim 1, wherein the controller is further configured to:
receive a set of first locating data associated with a plurality of wearable beacons; and
determine a priority order of the plurality of wearable beacons based on at least the set of first locating data.

15. The locating device according to claim 15, further comprising a wireless communication interface configured to transmit or receive search data with another on-site device, wherein the controller is further configured to determine the priority order of the plurality of wearable beacons based on at least the set of first locating data and the search data.

16. A method for using a locating device, the method comprising:
monitoring a first locating interface of the locating device for first locating data;
in response to receiving the first locating data comprising a first unique identifier of a wearable beacon, determining whether the wearable beacon is capable of transmitting at least three different locating signals based on at least the first locating data;
in response to determining that the wearable beacon is capable of transmitting at least three different locating signals, initiating a range tracking routine, a direction tracking routine, or both;
in response to initiating the range tracking routine, determining a range tracking parameter in response to second locating data from the wearable beacon; and
in response to initiating the direction tracking routine, determining a direction tracking parameter based on at least the first locating data and third locating data from the wearable beacon.

17. The method of claim 17, wherein the first locating data has a first packet size, the second locating data has a second packet size greater than the first packet size, the third locating data has a third packet size greater than the first packet size.

18. The method of claim 17, wherein the wearable beacon has bidirectional communication capability, wherein the controller is configured to establish bidirectional communication with the wearable beacon to receive the second locating data in response to initiating the range tracking routine.

19. A system comprising:
a wearable beacon configured to transmit at least three different locating signals each over a different communication protocol; and
the locating device of claim 1.
